(19) United States
(12) Patent Application Publication
(10) Pub. No.: US 2019/0178994 A1
(43) Pub. Date: Jun. 13, 2019

(54) LASER DISTANCE MEASURING DEVICE

(71) Applicant: HON HAI PRECISION INDUSTRY CO., LTD., New Taipei (TW)

(72) Inventor: PO-YU LIN, New Taipei (TW)

(21) Appl. No.: 15/859,762

(22) Filed: Jan. 2, 2018

(30) Foreign Application Priority Data
Dec. 7, 2017 (CN) 201711287559.7

(51) Int. Cl. G01S 7/486; G01S 17/10; G01S 7/481

(52) U.S. Cl. CPC G01S 7/4865; G01S 7/4861; G01S 7/4815; G01S 17/10

(57) ABSTRACT

A laser distance measuring device for measuring a distance between device and object comprises a plurality of substrates. Each substrate comprises a first surface carrying a laser diode, a photo diode, and a lens module. The laser diode and the photo diode are located at a side of the lens module away from the object. The laser diode emits lasers to the object, and the photo diode receives laser which is reflected by the object. The lens module focuses the outgoing and the incoming laser. The plurality of substrates being arranged in a divergent form improves Field of View of the measuring device, and the base supporting the substrates can be rotated to improve accuracy of the device in terms of multiple times of flight calculations applied to each substrate.

### FIELD

The subject matter herein generally relates to a laser distance measuring device.

### BACKGROUND

Laser distance measuring device has been widely used for measuring distance between an object and the device. Nowadays device with a large Field of View and a high measurement accuracy is preferred, thereby a laser distance measuring device with a large Field of View and a high measurement accuracy is needed.

### BRIEF DESCRIPTION OF THE DRAWINGS

Implementations of the present disclosure will now be described, by way of example only, with reference to the attached figures.

FIG. 1 is a diagrammatic view of a laser distance measuring device according to an exemplary embodiment of the present disclosure.

FIG. 2 is a diagrammatic view of a laser distance measuring unit in accordance with an exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better. The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising” when utilized, means “including, but not necessarily limited to”; it specifically indicates open-ended inclusion or membership in the so-described combination, group, series, and the like. The term “about” when utilized, means “not only includes the numerical value, but also includes numbers closest to the numerical value”.

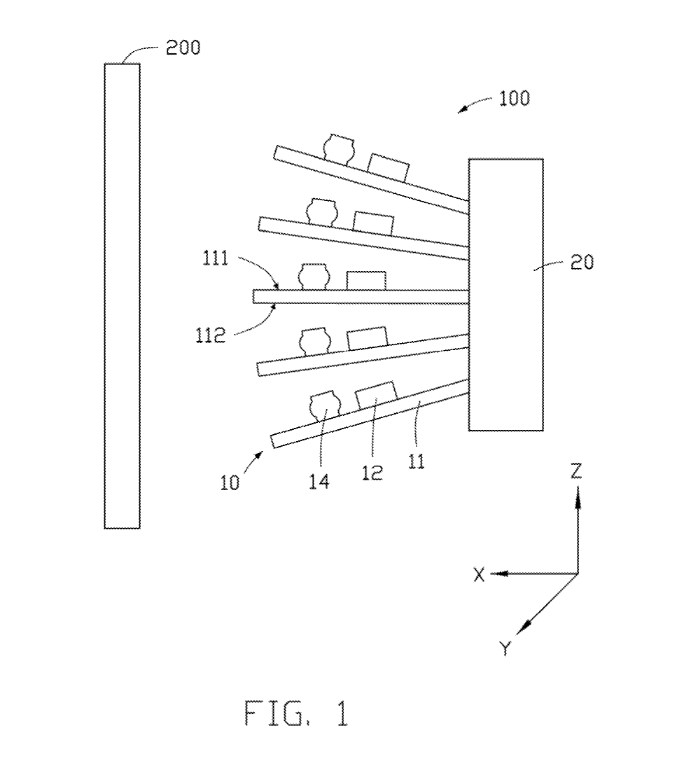

FIG. 1 illustrates an exemplary embodiment of a laser distance measuring device 100. The laser distance measuring device 100 is configured to measure a distance between the laser distance measuring device 100 and an object 200.

The laser distance measuring device 100 includes a plurality of substrates 11. The plurality of substrates 11 are arranged divergently, in other words, the extension surfaces to the reverse of each of the plurality of substrates 11 are convergent. Each of the plurality of substrates 11 includes a first surface 111, and a second surface 112 opposite to the first surface 111. The first surfaces 111 of the plurality of substrates 11 face roughly the same direction.

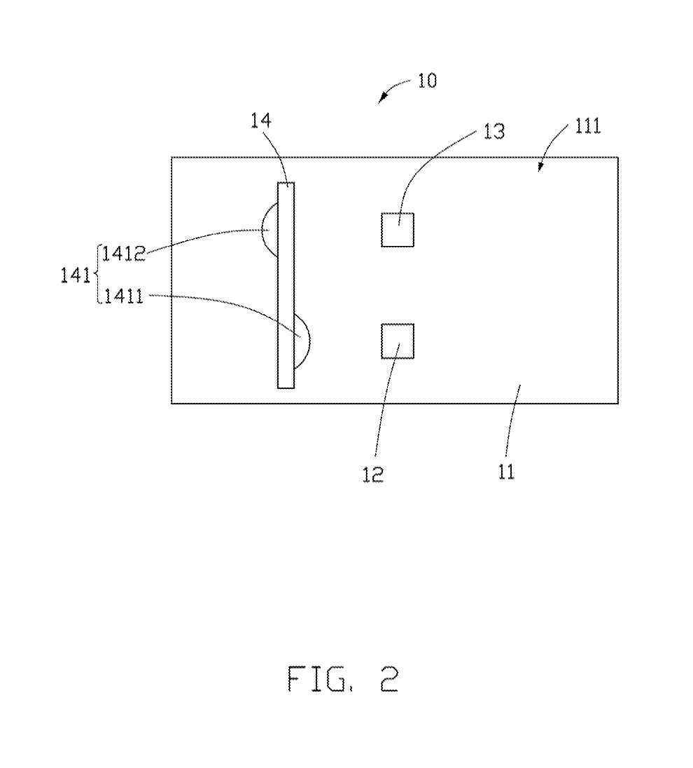

Referring to FIG. 2, a laser diode 12, a photo diode 13, and a lens module 14 are mounted to the first surface 111 of each of the plurality of substrates 11 to form a laser distance measuring unit 10. The laser diode 12 and the photo diode 13 are located at a side of the lens module 14 away from the object 200. The laser diode 12 is configured to emit lasers to the object 200. The photo diode 13 is configured to receive reflections from the object 200. The lens module 14 is configured to focus the lasers emitted by the laser diode 12 onto the object 200. The lens module 14 is also configured to focus the lasers reflected by the object 200, to ensure more lasers irradiate to the photo diode 13.

The plurality of substrates 11 being arranged in a divergent form improves Field of View (FOV) of the laser distance measuring device 100, thereby improve accuracy of the distance measuring result.

In at least one exemplary embodiment, inclined angles of each two adjacent substrates 11 are equal. In other exemplary embodiment, the inclined angles of each two adjacent substrates 11 are not equal.

In at least one exemplary embodiment, the substrate 11 is a circuit board. The laser diode 12 and the photo diode 13 mounted on the circuit board are electrically connected with the circuit board.

In at least one exemplary embodiment, the laser diode 12 is an edge-emitting laser diode. An emitting surface of the edge-emitting laser diode faces towards the lens module 14 and is perpendicular to the substrate 11.

The lens module 14 includes at least one optical lens 141. Each optical lens 141 includes a collimating lens portion 1411, and a focusing lens portion 1412. The collimating lens portion 1411 faces towards the laser diode 12. The focusing lens portion 1412 faces towards the photo diode 13. The collimating lens portion 1411 is configured to focus the lasers emitted by the laser diode 12, to ensure greater irradiation of the object 200. The focusing lens portion 1412 is configured to focus the laser reflections, to ensure more complete irradiation of the photo diode 13.

In at least one exemplary embodiment, the collimating lens portion 1411 is integrally formed with the focusing lens portion 1412. In other exemplary embodiment, the collimating lens portion 1411 is separated from the focusing lens portion 1412.

When the lens module 14 includes two or more optical lenses 141, the two or more optical lenses 141 are arranged in a direction from the laser diode 12 and the photo diode 13 towards the object 200, and the collimating lens portions 1411 of the two or more optical lenses 141 are arranged in a line. The focusing lens portions 1412 of the two or more optical lenses 141 are arranged in a line.

The optical lens 141 may be made of glass or plastic.

A light propagation path is that lasers are emitted out from the laser diode 12, pass through the collimating lens portion 1411, irradiate the object 200 and be reflected therefrom. The reflected lasers pass through the focusing lens portion 1412, and are finally received by the photo diode 13.

The laser distance measuring device 100 further includes a signal processing module (not shown). The signal processing module is electrically connected with the laser diode 12 and the photo diode 13 of each laser distance measuring unit 10. The signal processing module can record the process of the laser diode 12 emitting laser and the process of the photo diode 13 receiving reflected laser. A total time of flight (TOF) tₙ of the laser from the laser diode 12 to the photo diode 13 is thus known. A distance Lₙ between the laser distance measuring unit 10 and the object 200 can be calculated by a formula Lₙ=ctₙ/2, where c represents the speed of light, and n represents the total number of the laser distance measuring unit 10. A distance L between a laser distance measuring device 100 and the object 200 can be calculated by a formula L=(L₁+L₂+ . . . +Lₙ)/n.

The laser distance measuring device 100 further includes a motor 20. An end of each of the plurality of substrates 11 is mounted on the motor 20. The plurality of substrates 11 diverge along a direction away from the motor 20.

Referring to FIG. 1, an X-Y-Z coordinate system is built. X-axis is in a horizontal direction, Z-axis is in an upwards direction perpendicular to the X-axis, and Y-axis is in a direction perpendicular to the X-axis and the Z-axis. The motor 20 can drives the plurality of substrates 11 to revolve around the X-axis, so the substrates 11 in effect move back and forth along the Y-axis and up and down along the Z-axis. Thus measuring angles of the laser distance measuring device 100 can be adjusted.

In at least one exemplary embodiment, the motor 20 can drive the plurality of substrates 11 to periodically revolve, to achieve an effect of laser scanning from the Y and Z axes which improves accuracy of the measuring operation.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A laser distance measuring device comprising:
a plurality of substrates, each substrate comprises a first surface;
wherein the first surface of each substrate is mounted with a laser diode, a photo diode, and a lens module;
wherein the laser distance measuring device measure a distance between the laser distance measuring device and an object, the laser diode and the photo diode are located at a side of the lens module away from the object, the laser diode emits lasers to the object, the photo diode receives lasers reflected by the object, the lens module focuses the lasers emitted by the laser diode, and focuses the lasers reflected by the object.

2. The laser distance measuring device of claim 1, wherein the plurality of substrates are arranged in a divergent form.

3. The laser distance measuring device of claim 1, wherein each substrate is a circuit board, the laser diode and the photo diode mounted on the circuit board are electrically connected with the circuit board.

4. The laser distance measuring device of claim 1, wherein the laser diode is an edge-emitting laser diode, an emitting surface of the edge-emitting laser diode faces towards the lens module and is perpendicular to the substrate.

5. The laser distance measuring device of claim 1, wherein the lens module comprises at least one optical lens.

6. The laser distance measuring device of claim 5, wherein each optical lens comprises a collimating lens portion facing towards the laser diode, and a focusing lens portion facing towards the photo diode, the collimating lens portion focuses the lasers emitted by the laser diode, and the focusing lens portion focuses lasers reflected by the object.

7. The laser distance measuring device of claim 6, wherein the collimating lens portion is integrally formed with the focusing lens portion.

8. The laser distance measuring device of claim 5, wherein the optical lens is made of glass or plastic.

9. The laser distance measuring device of claim 2, wherein inclined angles of each two adjacent substrates are equal.

10. The laser distance measuring device of claim 1, wherein the laser distance measuring device further includes a motor, an end of each substrate is mounted on the motor, the plurality of substrates diverge along a direction away from the motor, the motor drives the plurality of substrates to revolve around.
